(19) United States
(12) Patent Application Publication
(10) Pub. No.: US 2013/0017444 A1
(43) Pub. Date: Jan. 17, 2013

(54) ELECTRODES FOR SECONDARY BATTERIES AND SECONDARY BATTERIES USING THE SAME

(71) Applicant: Kohei Honkura, Hitachi (JP)

(72) Inventor: Kohei Honkura, Hitachi (JP)

(73) Assignee: HITACHI, LTD., Tokyo (JP)

(21) Appl. No.: 13/547,401

(22) Filed: Jul. 12, 2012

(30) Foreign Application Priority Data
Jul. 12, 2011 (JP) 2011-153422

(51) Int. Cl. H01M 4/72

(52) U.S. Cl. 429/211

(57) ABSTRACT

Disclosed is an electrode for a secondary battery having an electrode compound layer including an electrode active material formed on a current collector, in which the electrode compound layer is provided with a plurality of voids disposed along the thickness direction of the electrode compound layer, the depth of the void is 50% or more of the thickness of the electrode compound layer, the projection area of the voids is 20% or less of the entire projection area of the electrode for a secondary battery, and the length of the cross section of the void is 5 μm to 100 μm.

### BACKGROUND OF THE INVENTION

1. Field of the Invention

The present invention relates to electrodes for secondary batteries and secondary batteries using the same.

2. Background Art

In recent years, electric vehicles for which a motor is used as a driving source that is driven based on power supplied from a secondary battery, hybrid vehicles for which a motor and an engine are jointly used as a driving source, natural energy power generation systems which incorporate a load leveling secondary battery, and the like have been shown.

In a case in which a secondary battery is used for the above uses, there is a demand for a secondary battery having both a function of storing a large amount of energy and a function of generating high output.

Currently, an electrode for an ordinary secondary battery is manufactured by forming an electrode compound layer including a binder, a conductive material, and an electrode active material on a metallic foil of a current collector. The positive electrode and the negative electrode are laminated oppositely through a separator so as to manufacture a secondary battery. In addition, an electrolytic solution is included in pores in the electrodes and the separator. Increasing the thickness of the electrode compound layer and decreasing the volume fraction of the metallic foil or the separator is an effective method for increasing the energy density of the secondary battery. However, increasing the thickness of the electrode compound layer degrades the permeability of the electrolytic solution. In a case in which large currents are made to flow in the electrodes, reactive species in the electrolytic solution start to be depleted from the side close to the current collector, and the active material nearby becomes useless such that favorable rate capability cannot be obtained. As such, in an electrode for which the energy density is increased by increasing the thickness of the electrode compound layer, there is a problem in that favorable rate capability cannot be obtained.

JP-T-2004-519078 describes an electrode that is improved in terms of the above aspects. The content is that the positive electrode, negative electrode, and separation film of the lithium secondary battery are all perforated at linear positions that are perpendicular to the electrode surface. The above configuration can increase the permeation rate of the electrolytic solution so as to improve the rate capability of the battery. In addition, JP-A-9-129223 proposes a method in which recess portions having a depth of 10% or less of the electrode thickness are scattered on the electrode surface so as to suppress cracking that is caused during winding of the electrode and improve the rate capability.

### SUMMARY OF THE INVENTION

In the improvement method according to JP-T-2004-519078, an effect of improving the rate capability of the battery can be expected. However, JP-T-2004-519078 does not include specific studies regarding the dimensions of the perforated portions. For example, JP-T-2004-519078 describes that the projection area of the perforated portions is a maximum of approximately 50% of the entire projection area of the electrode, but such a ratio is definitely excessive from the viewpoint of the energy density. In addition, when the diameter of the perforation is large, being 0.5 mm or 1.0 mm, as described in JP-T-2004-519078, the electrode area decreases, and the capacity degrades.

In the improvement method according to JP-A-9-129223, the depth of the recess portions is not sufficient, and the effect of increasing the permeation rate of the electrolytic solution so as to improve the rate capability is restrictive. The invention has been made in consideration of the above problems in the related art, and an object of the invention is to provide an electrode in which an electrode compound layer is thickened so as to increase the energy density and favorable rate capability is realized, and a secondary battery using the same.

The features of the invention for solving the above problems are as follows.

(1) An electrode for a secondary battery having an electrode compound layer includes an electrode active material formed on a current collector, in which the electrode compound layer is provided with a plurality of voids disposed along the thickness direction of the electrode compound layer, the depth of the void is 50% or more of the thickness of the electrode compound layer, the projection area of the voids is 20% or less of the entire projection area of the electrode for a secondary battery, and the length of the cross section of the void is 5 μm to 100 μm.

(2) In the electrode for a secondary battery, the plurality of voids are disposed in a triangular grid shape.

(3) In the electrode for a secondary battery, the length of the cross section of the void is 5 μm to 20 μm.

(4) In the electrode for a secondary battery, the depth of the void is 70% or more of the thickness of the electrode compound layer.

(5) In the electrode for a secondary battery, the projection area of the voids is 10% or less of the entire projection area of the electrode for a secondary battery.

(6) In the electrode for a secondary battery, the shape of the void is columnar.

(7) In the electrode for a secondary battery, in a graph showing the relationship between the discharge rate and the thickness of the electrode compound layer for outputting 0.075 mAh/g of the capacity per electrode active material unit mass, when the Y axis indicates the discharge rate for outputting 0.075 mAh/g of the capacity per electrode active material unit mass, the X axis indicates the thickness of the electrode compound layer, the thickness of the electrode compound layer is represented by X′ (μm) with the Y coordinate being 50% capacity rate capability I (1/h), the distance of the plurality of voids is represented by Z (μm), and the length of the cross section of the void is represented by R (μm), R≦Z≦(2X′+R) is met.

(8) In the electrode for a secondary battery, in a graph showing the relationship between the discharge rate and the thickness of the electrode compound layer for outputting 0.075 mAh/g of the capacity per electrode active material unit mass, when the Y axis indicates the discharge rate for outputting 0.075 mAh/g of the capacity per electrode active material unit mass, the X axis indicates the thickness of the electrode compound layer, the thickness of the electrode compound layer is represented by X′ (μm) with the Y coordinate being 50% capacity rate capability I (1/h), the thickness of the electrode compound layer is represented by T (μm), and the depth of the void is represented by D (T−X′)≦D is met.

(9) A secondary battery in which the electrode for a secondary battery is used for at least one of a positive electrode and a negative electrode.

According to the electrodes for secondary batteries and secondary batteries using the same of the invention, it is possible to provide an electrode that meets both favorable rate capability and high energy density. Objects, configurations, and effects which are not described above will be clarified in the following description of embodiments.

### BRIEF DESCRIPTION OF THE DRAWINGS

FIG. 1A is a top view of an example of an embodiment according to the invention.

FIG. 1B is a cross-sectional view of the example of the embodiment according to the invention.

FIG. 2 is a view showing the relationship between the thickness and rate capability during discharge of an electrode compound layer.

FIG. 3 is a view showing the relationship between the discharge rate for outputting 0.075 mAh/g of the capacity per active material unit mass and the single surface thickness of the electrode compound layer.

FIG. 4 is a view showing a secondary battery that is an example of an embodiment according to the invention.

### DETAILED DESCRIPTION OF THE INVENTION

Hereinafter, embodiments of the invention will be described using the accompanying drawings and the like. The following description simply shows specific examples of the invention, the invention is not limited to the description, and a person skilled in the art can make a variety of modifications and corrections within the scope of the technical ideas that are disclosed in the present specification. In addition, in all the drawings for describing the invention, the same reference sign will be given to components having the same function, and there are cases in which description thereof will not be repeated.

### Example 1

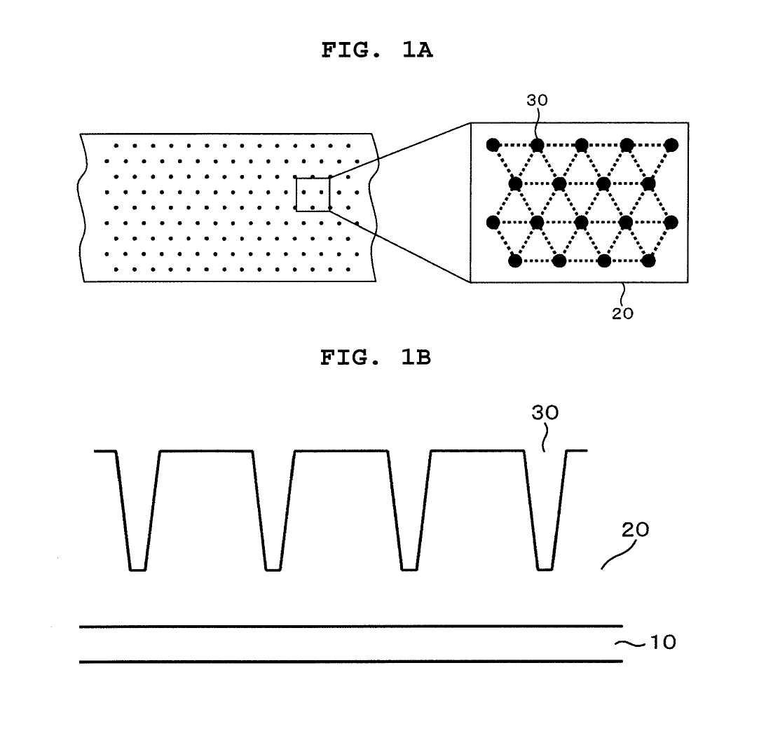

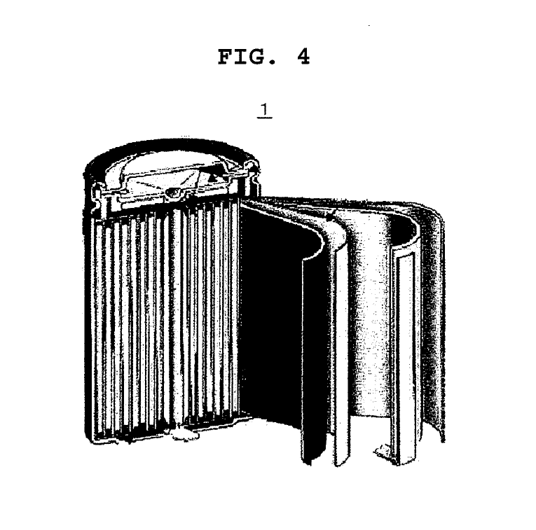

FIGS. 1A and 1B are views showing an example of an embodiment in an electrode for a secondary battery according to the invention. FIG. 4 shows a secondary battery 1 using the electrode for a secondary battery of FIGS. 1A and 1B.

FIG. 1A is a top view of an example of the embodiment. The secondary battery includes a lithium ion secondary battery, a nickel-hydrogen battery, and the like. In the electrode for a secondary battery of the embodiment, a number of fine voids are disposed on the electrode surface. In addition, the voids are disposed in a triangular grid so that the distance between the voids becomes constant. The distance between the voids may be randomly set, and the voids may be disposed in a rectangular grid. When the distance between the voids is set to be constant like a triangular grid, loads on the electrode active material are equally distributed, and local variation in the response capability of the active material can be suppressed.

In the voids, compared to pores in an electrode compound layer, battery reactive species included in an electrolytic solution diffuse at a high rate. Therefore, the active material present around the voids can be utilized in the same manner as the active material present near the interface between the electrode compound layer and a separator even when the active material is present near the interface between the electrode compound layer and a current collector 10. As a result, even in a case in which charge and discharge are carried out at a high rate, it is possible to bring out the capacity of the active material present near the interface between the electrode compound layer and the current collector 10, and the rate capability of the secondary battery improves.

In addition, FIG. 1B is a cross-sectional view of the example of the embodiment. In the embodiment, voids 30 are provided at equal intervals in an electrode compound layer 20 coated on the current collector 10. Meanwhile, while FIG. 1B shows the cross-sectional view of a single surface, in reality, the voids 30 are present in the same manner even on the opposite surface. The voids 30 may be provided only on a single surface of the current collector 10.

The shape of the battery can be a cylindrical shape, a flat oval shape, a rectangular shape, and the like, and the battery may have any shape as long as the electrode for a secondary battery can be housed. In the case of a rectangular or electrode-laminating battery, since small pieces of the electrode flow through a line one by one, pressing or a laser process can be easily carried out (compared to a case in which the electrode flows through the line continuously), and the battery is advantageous in terms of the manufacturing process.

The thickness T (μm) of the single surface of the electrode compound layer 20 differs by use. In a case in which outputting matters as in HEV, T becomes 30 μm to 40 μm. In a case in which the energy density is required as in PHEV, T becomes approximately 100 μm or more.

The positive electrode that is used for the secondary battery of the invention is formed by coating a positive electrode compound including a positive electrode active material, a conductive material, and a binder on both surfaces of an aluminum foil, and then drying and pressing the coatings. A material represented by a chemical formula of LiMO₂ (M is at least one kind of the transition metals), spinel manganese, or the like can be used as the positive electrode active material. Positive electrode active materials, such as lithium manganite, lithium nickelate, and lithium cobaltate in which some of Mn, Ni, Co, and the like are substituted by one or two or more kinds of transition metals, can be used. Furthermore, positive electrode active materials in which some of the transition metals are substituted by a metallic element, such as Mg or Al, also can be used. As the conductive material, a well-known conductive material, for example, a carbon-based conductive material, such as graphite, acetylene black, carbon black, or carbon fiber, may be used, and the conductive material is not particularly limited. As the binder, a well-known binder, for example, polyvinylidene fluoride or fluorine rubber, may be used, and the binder is not particularly limited. The preferable binder in the invention is, for example, polyvinylidene fluoride. In addition, a variety of well-known solvents can be appropriately selected and used as the solvent, and, for example, an organic solvent, such as N-methyl-2-pyrrolidone, is preferably used. The mixing ratio of the positive electrode active material, the conductive material, and the binder in the positive electrode compound is not particularly limited; however, for example, in a case in which the content of the positive electrode active material is set to 1, the mixing ratio is preferably 1:0.05 to 0.20:0.02 to 0.10 in terms of weight ratio.

The negative electrode that is used in the secondary battery of the invention is formed by coating a negative electrode compound including a negative electrode active material and the binder on both surfaces of a copper foil, and then drying and pressing the coatings. The preferable negative electrode in the invention is a carbon-based material, such as graphite or amorphous carbon. As the binder, for example, the same binder as for the positive electrode is used, and the binder is not particularly limited. The preferable binder in the invention is, for example, polyvinylidene fluoride. The preferable solvent is, for example, an organic solvent, such as N-methyl-2-pyrrolidone. The mixing ratio of the negative electrode active material and the binder in the negative electrode compound is not particularly limited; however, for example, in a case in which the content of the negative electrode active material is set to 1, the mixing ratio is 1:0.05 to 0.20 in terms of weight ratio.

As a non-aqueous electrolytic solution that is used in the secondary battery of the invention, a well-known electrolytic solution may be used, and the electrolytic solution is not particularly limited. Examples of the non-aqueous solvent include propylene carbonate, ethylene carbonate, butylene carbonate, vinylene carbonate, dimethyl carbonate, diethyl carbonate, methyl ethyl carbonate, tetrahydrofuran, 1,2-diethyoxy ethane, and the like. The non-aqueous electrolytic solution can be prepared by dissolving one or more kinds of lithium salts selected from, for example, LiPF₆, LiBF₄, LiClO₄, and the like in one or more kinds of the above solvents.

The shape and positional relationship of the voids 30 in FIG. 1 vary by the energy density and the rate capability that the battery requires. An example of the designing method will be described below. Here, an example of the designing method of the voids 30 on the positive electrode side will be described, but the voids 30 on the negative electrode side can be designed in the same manner. Since the negative electrode is molded at a high density (a low porosity) more frequently than the positive electrode, the diffusivity of lithium in the electrode pores is smaller in the negative electrode than the positive electrode. Therefore, providing the voids in the negative electrode rather than the positive electrode produces a large contributing effect of the voids of the invention. In a case in which the voids 30 are provided in both the positive electrode and the negative electrode, the depth of the voids 30 in the negative electrode is desirably set to be larger than the depth of the voids 30 in the positive electrode. In addition, the method of designing the electrode structure of the invention is not limited to the following computation example.

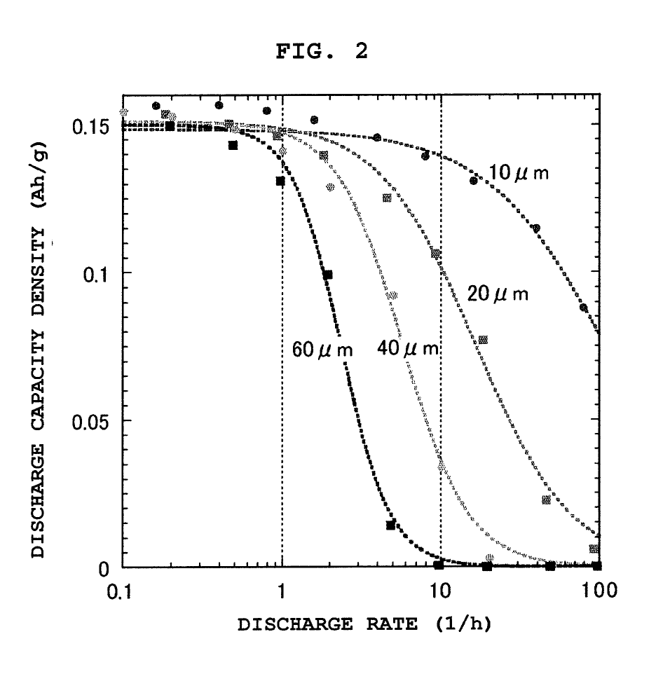

Firstly, the discharge capacity W per unit area of a single electrode surface and the rate capability I which the positive electrode demands are, determined. Based on the discharge capacity W and the rate capability I, the inter-void distance corresponding to the demanding rate capability is determined. Regarding the positive electrode of the flat-coated secondary battery, the inventors investigated the relationship between the thickness and rate capability during discharge of the electrode compound layer 20 on a single surface of the positive electrode. FIG. 2 shows the results. In the drawing, the horizontal axis indicates the discharge rate capability, and the vertical axis indicates the discharge capacity normalized by the mass of the electrode active material that is included in the electrode compound layer 20. As the electrode active material, lithium cobaltate having a discharge capacity of approximately 0.15 mAh/g was used. As shown in the drawing, it is found that the rate capability degrades as the thickness of the electrode compound layer 20 increases, and the average permeation distance of the electrolytic solution to reach the active material increases.

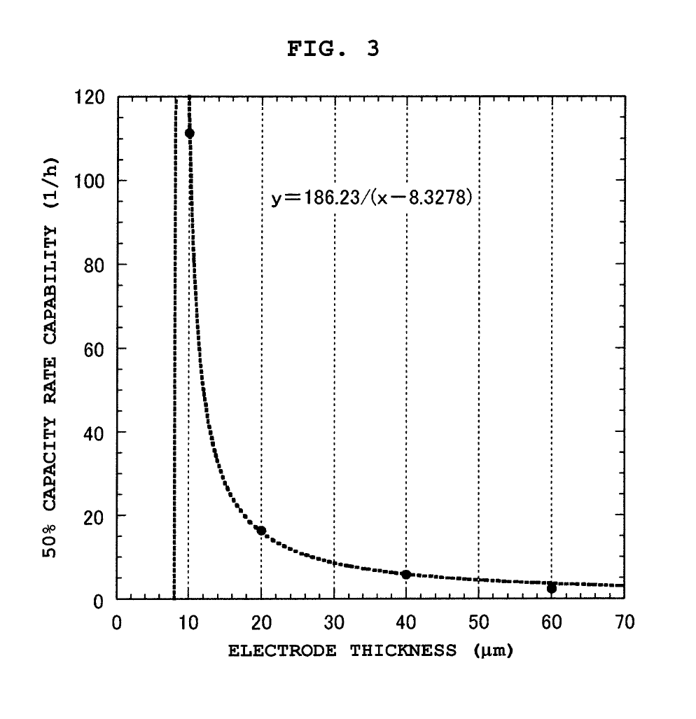

FIG. 3 is a view showing the relationship between the discharge rate for outputting 0.075 mAh/g of the capacity per active material unit mass and the single surface thickness of the electrode compound layer 20 in the rate capability shown in FIG. 2. The thickness X′ (μm) of the electrode compound layer 20 when the Y coordinate indicates the demanding rate I (1/h) in the curve of FIG. 3 refers to a distance from the interface between the electrolytic solution and the electrode compound layer 20 to the interface between the active material and the current collector 10 for meeting the demanding rate I. The inter-void distance is determined using the X′. When the diameter (length) of the void 30 on the top view of the electrode is represented by R, the inter-void distance Z (μm) is preferably determined to be R to (2X′+R). When Z becomes larger than 2X′+R, the distance from the electrolytic solution portion in the bulk is long, and therefore there is a possibility of an increase in the amount of the active material that cannot exhibit the demanding rate capability.

The diameter R of the void 30 needs to be large enough for the reactive species in the electrolytic solution to diffuse, preferably 5 μm to 100 μm, and more preferably in a range of 5 μm to 20 μm. In FIG. 1B, the diameters R (μm) of the plurality of voids 30 are constant; however, in a case in which the diameters of the plurality of voids 30 are not constant, the average value of the diameter of the plurality of voids 30 may be set to R, or the diameter of the shallowest void 30 may be set to R. In a case in which the void 30 is oval, the diameter R (μm) indicates the short axis of the void 30.

The depth D (μm) of the void 30 is preferably in a range of (T−X′)≦D≦T with respect to the thickness T (μm) of a single surface of the electrode compound layer 20 and X′. When (T−X′)≦D is met, it is possible to make the active material present in a range of the bottom surface of the void 30 to the depth X′ function at the demanding rate I (1/h). In the case of D=T, the rate capability can be improved. In the case of D<T, since the volume of the electrode compound increases compared to the case of D=T, the capacity increases. When the depth D of the void 30 is set to 50% or more of T, the permeation rate of the electrolytic solution into the vicinity of the active material present in the depth portion of the electrode compound layer 20 increases, and favorable rate capability can be provided with no regard to the thickness of the electrode compound layer 20. The depth D of the void 30 is more preferably set to 70% or more of T. In FIG. 1B, the depths D (μm) of the plurality of voids 30 are constant; however, in a case in which the depths of the plurality of voids 30 are not constant, the average value of the depths of the plurality of voids 30 may be set to D, or the depth of the shallowest void 30 may be set to D.

The single surface thickness T of the electrode compound layer 20 can be determined from the discharge capacity W (mAh/cm²) per unit area, which is required for the positive electrode, X′, the electrode density ρ (g/cm³), and the ratio A of the active material included in the electrode compound. The ratio A is desirably 0.8 to 0.95.

Firstly, in a case in which the shape of the void 30 is columnar, the volume of the void 30 is approximately (πR²D/4). In a case in which the shape of the void 30 is conical, the volume of the void 30 is approximately πR²D/12. In the following description, the shape of the void 30 is considered to be columnar. In a case in which the shape of the void 30 is conical, the volume is converted and then considered. As the shape of the void 30, the columnar shape is more desirable than the conical shape since the force for supplying lithium ions to the active material near the front end portion of the void 30 is strong.

The single surface thickness T of the electrode compound layer 20 is preferably 50 μm to 200 μm, and more preferably in a range of 100 μm to 150 μm.

Since one triangular grid includes half the void 30, and the volume of one triangular grid is (√ 3/4×Z²T), the volume of the electrode compound layer 20 when the volume of (the electrode compound layer 20+the void 30) is 1 is (1−√3×πR²D/6Z²T). Therefore, the volume of the electrode compound per electrode unit area is (T−√3×πR²D/6Z²). A numeric value obtained by multiplying (T−√3×πR²D/6Z²) by Aρ is the weight of the electrode active material. When the capacity per unit weight of the electrode active material is represented by C, T can be determined so that the demanding discharge capacity W meets

W≦CAρ(T−√3×πR²D/6Z²).

A specific design example is that the capacity W of the single surface per the demanding positive electrode unit area is 4 mAh/cm², and the demanding rate capability I is set to 10 hour rate. In addition, lithium cobaltate having a capacity density C of 0.15 Ah/g is used as the positive electrode active material. In addition, the weight ratio A of the active material included in the electrode compound layer 20 is set to 0.9, and the density ρ of the electrode compound layer 20 is set to 3 g/cm³. In addition, the diameter R of the void 30 is set to 20 μm. In addition, the inter-void distance Z is set to (2X′+R), and the depth D of the void 30 is set to (T−X′).

The projection area of the voids 30 with respect to the entire projection area of the electrode for a secondary battery is obtained using a ratio between the area of the unit grid of the triangular grid and half the area of the void 30. When the projection area of the voids 30 is set to 20%, preferably 10% or less of the entire projection area of the electrode for a secondary battery, the electrode for which degradation of the energy density is suppressed can be provided.

Firstly, FIG. 3 shows that the characteristic distance X′ for meeting the demanding rate capability I is 26.95 μm. Then, the inter-void distance Z is 73.90 μm, and the depth D of the void 30 is (T−26.95). When the above values are substituted in the above formula, it is found that the single surface thickness T of the electrode compound layer 20 needs to be 100.0 μm. In addition it is found that the depth D of the void 30 needs to be 73.09 μm. The ratio of the volume of the voids 30 to the volume of (the electrode compound layer 20+the voids 30) in this case, that is, the ratio of the projection area of the voids 30 to the entire projection area of the electrode for a secondary battery is 6.6%.

As described above, when the voids 30 having a diameter of 20 μm and a depth of 73 μm are disposed in a triangular grid shape so that the inter-void distance is 74 μm in the electrode compound layer 20 having a single surface thickness of 104 μm, an electrode that has a single surface capacity of 4 mAh/cm² and can tolerate use under discharge of up to 10 hour rate can be obtained.

The method of forming the voids 30 in the electrode compound layer 20 in the invention is not particularly limited. For example, the voids may be formed by flat-coating a slurry-form electrode compound on the current collector 10, and then carrying out molding using a pressing machine having protrusion portions that correspond to the voids 30 in the electrode compound layer 20 on the surface. In addition, for example, the voids 30 disposed in a triangular grid shape on the flat-coated electrode may be formed by manufacturing a mask having a pattern in which holes are disposed in a triangular grid shape, and carrying out a laser process using the mask.

### Example 2

Another design example other than Example 1 is that the capacity W of the single surface per the demanding positive electrode unit area is 4 mAh/cm², and the demanding rate capability I is set to 30 hour rate. In addition, lithium cobaltate having a capacity density C of 0.15 Ah/g is used as the positive electrode active material. In addition, the weight ratio A of the active material included in the electrode compound layer 20 is set to 0.9, and the density ρ of the electrode compound layer 20 is set to 3 g/cm³. In addition, the diameter R of the void 30 is set to 20 μm. In addition, the inter-void distance Z is set to (2X′+R), and the depth D of the void 30 is set to (T−X′).

Firstly, FIG. 3 shows that the characteristic distance X′ for meeting the demanding rate capability I is 14.54 μm. Then, the inter-void distance Z is 49.07 μm, and the depth D of the void 30 is (T−14.54). When the above values are substituted in the above formula, it is found that the single surface thickness T of the electrode compound layer 20 needs to be 108.5 μm. In addition, it is found that the depth D of the void 30 needs to be 94.01 μm. The ratio of the volume of the voids 30 to the volume of (the electrode compound layer 20+the voids 30) in this case is 15.1%.

As described above, when the voids 30 having a diameter of 20 μm and a depth of 94 μm are disposed in a triangular grid shape so that the inter-void distance is 49 μm in the electrode compound layer 20 having a single surface thickness of 114 μm, an electrode that has a single surface capacity of 4 mAh/cm² and can tolerate use under discharge of up to 30 hour rate can be obtained.

### Example 3

The other design example other than Example 1 is that the capacity W of the single surface per the demanding positive electrode unit area is 4 mAh/cm², and the demanding rate capability I is set to 100 hour rate. In addition, lithium cobaltate having a capacity density C of 0.15 Ah/g is used as the positive electrode active material. In addition, the weight ratio A of the active material included in the electrode compound layer 20 is set to 0.9, and the density ρ of the electrode compound layer 20 is set to 3 g/cm³. In addition, the diameter R of the void 30 is set to 10 μm. In addition, the inter-void distance Z is set to (2X′+R), and the depth D of the void 30 is set to (T−X′).

Firstly, FIG. 3 shows that the characteristic distance X′ for meeting the demanding rate capability I is 10.19 μm. Then, the inter-void distance Z is 30.38 μm, and the depth D of the void 30 is (T−10.19). When the above values are substituted in the above formula, it is found that the single surface thickness T of the electrode compound layer 20 needs to be 106.2 μm. In addition, it is found that the depth D of the void 30 needs to be 96.00 μm. The ratio of the volume of the voids 30 to the volume of (the electrode compound layer 20+the voids 30) in this case is 9.8%.

As described above, when the voids 30 having a diameter of 10 μm and a depth of 96 μm are disposed in a triangular grid shape so that the inter-void distance is 30 μm in the electrode compound layer 20 having a single surface thickness of 109 μm, an electrode that has a single surface capacity of 4 mAh/cm² and can tolerate use under discharge of up to 100 hour rate can be obtained.

Use of the secondary battery according to the invention is not particularly limited. For example, the secondary battery according to the invention is usable as a power supply of mobile information communication devices, such as personal computers, word processors, cordless telephone handsets, electronic book readers, mobile phones, car phones, handy terminals, transceivers, and portable radios. In addition, the secondary battery according to the invention is usable as a power supply of a variety of mobile devices, such as portable copy machines, electronic diaries, calculators, liquid crystal televisions, radios, tape recorders, headphone stereos, portable CD players, video movies, electric shavers, electronic translating machines, voice-input devices, and memory cards. In addition, the secondary battery according to the invention is usable in domestic electric devices, such as refrigerators, air conditioners, televisions, stereos, water heaters, oven microwaves, dish washers, dryers, laundry machines, lighting devices, and toys. In addition, use is possible as a battery for domestic and business electric power tools and nursing tools (electric power wheelchairs, electric power beds, electric power bathing facilities, and the like). Furthermore, the invention can be applied as an industrial power supply for medical devices, construction machines, power storage systems, elevators, and unmanned moving vehicles, and, furthermore, as a power supply for moving bodies, such as electric vehicles, hybrid electric vehicles, plug-in hybrid electric vehicles, golf carts, and turret cars. Furthermore, the secondary battery according to the invention is also usable as a power storage system in which power generated from a solar battery or a fuel battery is charged in the battery module of the invention, and which can be used in an area other than those on the earth, such as in space stations, space shuttles, and space bases. Since an object of the invention is a large-capacity battery and a high-rate characteristics, the invention is particularly desirably used for electric vehicles, plug-in hybrid electric vehicles, load leveling of wind power generation, or the like, which are uses demanding both characteristics.

What is claimed is:

1. An electrode for a secondary battery comprising:
an electrode compound layer including an electrode active material formed on a current collector,
wherein the electrode compound layer is provided with a plurality of voids disposed along the thickness direction of the electrode compound layer,
the depth of the void is 50% or more of the thickness of the electrode compound layer,
the projection area of the voids is 20% or less of the entire projection area of the electrode fora secondary battery, and
the length of the cross section of the void is 5 μm to 100 μm.

2. The electrode for a secondary battery according to claim 1,
wherein the plurality of voids are disposed in a triangular grid shape.

3. The electrode for a secondary battery according to claim 1,
wherein the length of the cross section of the void is 5 μm to 20 μm.

4. The electrode for a secondary battery according to claim 1,
wherein the depth of the void is 70% or more of the thickness of the electrode compound layer.

5. The electrode for a secondary battery according to claim 1,
wherein the projection area of the voids is 10% or less of the entire projection area of the electrode for a secondary battery.

6. The electrode for a secondary battery according to claim 1,
wherein the shape of the void is columnar.

7. The electrode for a secondary battery according to claim 1,
wherein, in a graph showing the relationship between the discharge rate and the thickness of the electrode compound layer for outputting 0.075 mAh/g of the capacity per electrode active material unit mass,
when the Y axis indicates the discharge rate for outputting 0.075 mAh/g of the capacity per electrode active material unit mass,
the X axis indicates the thickness of the electrode compound layer,
the thickness of the electrode compound layer is represented by X′ (μm) with the Y coordinate being 50% capacity rate capability I (1/h),
the distance of the plurality of voids is represented by Z (μm), and
the length of the cross section of the void is represented by R (μm),
R≦Z≦(2X′+R) is met.

8. The electrode for a secondary battery according to claim 1,
wherein, in a graph showing the relationship between the discharge rate and the thickness of the electrode compound layer for outputting 0.075 mAh/g of the capacity per electrode active material unit mass,
when the Y axis indicates the discharge rate for outputting 0.075 mAh/g of the capacity per electrode active material unit mass,
the X axis indicates the thickness of the electrode compound layer,
the thickness of the electrode compound layer is represented by X′ (μm) with the Y coordinate being 50% capacity rate capability I (1/h),
the thickness of the electrode compound layer is represented by T (μm), and
the depth of the void is represented by D (μm),
(T−X′)≦D is met.

9. A secondary battery,
wherein the electrode for a secondary battery according to claim 1 is used for at least one of a positive electrode and a negative electrode.
